(19) United States
(12) Patent Application Publication
(10) Pub. No.: US 2013/0289960 A1
(43) Pub. Date: Oct. 31, 2013

(54) PROCESS FOR CHARACTERISING THE EVOLUTION OF AN OIL OR GAS RESERVIOR OVER TIME

(71) Applicants: Andrea Grandi, Sola (NO); Darrell Ardon Coles, Salem, MA (US)

(72) Inventors: Andrea Grandi, Sola (NO); Darrell Ardon Coles, Salem, MA (US)

(21) Appl. No.: 13/704,027

(22) PCT Filed: Jun. 24, 2011
(86) PCT No.: PCT/EP2011/060625

§ 371 Date: Jul. 16, 2013

(30) Foreign Application Priority Data
Jun. 25, 2010 (GB) 1010718.3

(51) Int. Cl. G01V 1/30

(52) U.S. Cl. CPC G01V 1/30
USPC 703/10

(57) ABSTRACT

Disclosed is a process for characterising the evolution of a reservoir by co-analyzing the changes in the propagation times and seismic amplitudes of seismic reflections. The method comprises the steps of: providing a base survey of the reservoir with a set of seismic traces at a first time; providing a monitor survey of the reservoir, taken at a second time, with a set of seismic traces associated to the same positions as in the base survey; and characterising the evolution of the reservoir by inversion to obtain an estimate of the changes having occurred during the time interval between base and monitor surveys. The inversion is regularized by the imposition of a sparsity constraint, such as Cauchy sparsity, which favours inversion solutions for which most of the solution values are equal to zero, while large values of said inversion solutions are preserved.

The present invention relates generally to the field of geosciences and more particularly to seismic data processing. Specifically the invention relates to a method to extract the time-lapsed changes in 3D seismic data sets collected over a production period to integrate with production data and assist in understanding and managing the extraction of oil and gas from reservoirs or the injection of other fluids into the reservoirs.

In the oil and gas industry, seismic surveys are carried out in order to provide subsurface images so that accumulations of hydrocarbons or other fluids might be identified. In a seismic survey, one or several sources emit elastic waves in the form of pressure or ground motion modulation from specific locations (wavefield), at or below the land or sea surface or in a borehole. This wavefield propagates away from the source(s) through the subsurface. Along with this propagation, a fraction of the incident wavefield is reflected from the heterogeneities in the elastic material properties of the subsurface (such as acoustic impedance). This excitation by the incident wavefield generates a reflected wavefield from the heterogeneities, which manifests as pressure, particle motion or some derived quantities and can be detected and recorded at the surface or in a borehole at a number of receiver locations.

Processing of the measurements is undertaken so as to construct a 3D image of the sub-surface. Repeated surveys at selected time intervals (days, months, years) allow observation of the changes in, over or under a given reservoir across the time interval—e.g. before oil or gas production starts and after some period of production or injection and to compare the results of measurements. This is called 4D seismic and involves comparing 2D or 3D seismic surveys carried out at different time instances. The aim is to observe changes in the state of the formations and fluids consequent upon production of hydrocarbons from or the injection of fluids into a reservoir. Proper detection of the changes and proper identification of the effects, factors and processes requires specialised acquisition techniques and data processing steps. Seismic processing compensates for variations in acquisition (or non-repeatability of seismic surveys) and changes in velocity in the sub-surface.

There are a number of ways to retrieve accurate 4D signal. One method is to add strong model constraints by performing what is generally called model driven inversions. For instance, full elastic inversions with strong prior information drive 4D effects to occur only in model-specified zones defined by the geological and reservoir models; other types of inversions assume initial solutions compatible with initial models. In both these methods, initial model assumptions have a tremendous impact on the final result; however these models contain inaccuracies because they are based on the 3D extrapolation of local information from few wells and geological a priori knowledge of the area and its genesis. Therefore, when strong model constraints are used in the process of masking 4D noise and artefacts, often geo-model errors are introduced and/or real 4D effects are also masked. Conversely, when results are obtained via data-driven methods, 4D information is fully complementary to geo-models and can be used to modify the these models, whereas model updates have to be done carefully when 4D are biased by strong a priori assumptions. In conclusion, these model-driven inversions may diminish the value of time lapse seismic information, in terms of its ability to provide unexpected objective information. Another important drawback is that if a priori model information is extensively used to improve model results, then it is not anymore possible to use this kind of information for QC purposes.

Other techniques applied to detect 4D changes are hereafter referred to as warping. The standard technique makes use of cross-correlation between different surveys in selected windows. Such a window is a time interval representing a portion of a trace. One problem with these correlation-based approaches is the size of the correlation window. If the window used for correlation is too large, the accuracy of correlation is likely to be affected: indeed, the correlation value will then depend not only on differences between the survey at the point being considered, but also on other effects, apart from the points being considered. If the window used for correlation is too small, correlation is likely to be severely affected by noise and non-repeatability of the surveys, including changes due to the effects whose observation is desired.

In EP 1 865 340 to the Applicant, and incorporated herein by reference, the evolution of an oil reservoir in the process of producing is carried out by jointly inverting for the changes in the propagation times and seismic amplitudes of a seismic wavelet along propagation paths in the ground. Inverting allows to back filter, in effect, deriving the original from the solution. A base survey of the reservoir is provided, with a set of seismic traces at a first time T associated to a first velocity field V_{b} ; a monitor survey of the reservoir is provided, the monitor survey being taken at a second time T+ΔT, with a set of seismic traces associated to the same positions as in the base survey; the monitor survey is associated to a second velocity field Vₘ. For a set of samples i in the base survey, one computes over the samples of the set the sum S of a norm of the difference between
the amplitude bᵢ of the seismic trace in the base survey at each sample i and
the sum of the amplitude m_{i′} of the seismic trace at a time-corresponding i′ in the monitor survey and the amplitude due to the reflectivity change local to the time-corresponding sample i′ induced by the difference between the first velocity field V_{b} and the second velocity field Vₘ; the time-corresponding sample i′ being shifted in time by a time-shift derived from the velocity changes along the propagation path from the surface to time-corresponding sample i′. This sum is minimised to derive the velocity changes from the base survey to the monitor survey and thus characterise the evolution of the reservoir.

This analysis is based on the fact that changes in the reservoir, due to exploitation, will cause changes to the petrophysical properties of the rock and therefore to the seismic velocity field. Practically, oil will be substituted by gas or water and/or the fluid pressure will change, modifying saturation, porosity, permeability and pressure, and consequently in velocity. Changes within the reservoir may also perturb the stress and strain state of the surrounding rocks, further altering their velocities. These changes to velocity will produce time shifts in the seismic response of underlying reflectors and associated changes in reflectivity, causing an alteration of the local wavefield. By using an inversion technique, for every point in the 3D volume, an estimate of the 4D changes having occurred in the time lapse between collection of the base and monitor surveys is provided. It is therefore possible to deduce a field of 4D velocity changes without having to proceed with cross correlation of the traces.

In EP 1 865 340, warping is posed as an inverse problem in which a cost function is minimised with respect to 4D relative changes in velocity (model parameter values). In warping, this cost function is generally defined as

$$C = {\sum }_{i = 1}^{N} {( b ( {t}_{i} ) - m ( {t}_{i} - {t}_{s} {\sum }_{k = 1}^{i} \frac{Δ V}{V} ( k ) ) + {( w ( t ) * \frac{Δ V}{V} ( t ) )}_{i} )}^{2} \qquad ( 1 )$$

where b and m are respectively the base and the monitor trace, t_{S} is the sampling rate of the seismic data,

$$\frac{Δ V}{V}$$

is the relative velocity 4D change, w is a seismic operator depending on the wavelet and * denotes the convolution between this operator and the relative velocity change to model the 4D amplitude change. Usually the cost function is computed over all the available time-samples but it can be also calculated for decimated time samples, or, conversely, the sample number can be increased by interpolation to improve the accuracy of the solution. Moreover, the inversion can be focussed on the most relevant layers in the field (including overburden, reservoir, and underburden), with relevance being determined through stratigraphic information or any other strategy. The advantage of working with sub-samples is that it can make the inversion better posed.

The above cost function expresses the difference between base and monitor seismic data and should be minimised using an appropriate solver algorithm. This 4D inversion problem is ill-posed; that is, there are multiple solutions that will minimise the above cost function. For instance, a localised, smooth, zero-mean velocity change will mediate zero time-shift and thus will not generate any 4D amplitude difference. In effect, such localised perturbations can be added to a candidate solution without causing the cost function to increase or decrease. Therefore, if a ‘best’ solution exists that minimises the cost function then any solution formed by adding one of these localised perturbations to it also equally minimises the cost function, showing that solutions to the inverse problem are non-unique.

One method to deal with solution non-uniqueness, as well as approximate forward models and data noise is to add a model regularisation term to the cost function. Regularisation supplies additional information about the characteristics of the model that is not contained (or that is concealed) in noise-contaminated data, such as its smoothness, total energy, and so on. Furthermore, model constraints imposed by regularisation help to stabilise the inversion and to avoid overfitting noise in the data. Model regularisation is implemented by adding a term to the cost function that penalises model solutions that do not exhibit such expected characteristics and, in the context of warping inversion, takes the general form

$$C = {\sum }_{i = 1}^{N} {( b ( {t}_{i} ) - m ( {t}_{i} - {t}_{s} {\sum }_{k = 1}^{i} \frac{Δ V}{V} ( k ) ) + {( w ( t ) * \frac{Δ V}{V} ( t ) )}_{i} )}^{2} + λ {\sum }_{i = 1}^{N} f ( \frac{Δ V}{V} ( t ) ) , \qquad ( 2 )$$

where f is a regularisation functional that quantifies the degree to which a model diverges from the characteristic(s) it would be desirable for the solution to possess. The regularisation weight λ controls the trade off between modelling 4D changes from the seismic data and imposing the constraint on the solutions. As alluded to above, there are many forms of regularisation functional that can be applied to the ΔV/V model.

As regularisation imposes additional constraints on the model solution, it needs to be tailored to the particular problem being solved. When the model solution of an ill-posed problem is expected to have small values, the most commonly used regularisation is L₂ Tikhonov regularisation because it favours solutions with this property. It adds a penalty to the cost function that is proportional to their total energy (equation 3 below). Alternately, to mediate smooth solutions L₂ Tikhonov regularisation can be applied to the differences between adjacent model parameters (equation 4 below). In this case the penalty to the cost function is proportional to the energy of relative deviations between adjoining parameters. These regularisation schemes exemplify two possible ways in which the cost function can be adapted to a particular inverse problem: the first constrains the model solution to have minimum energy; the second constrains the model solution to be smooth.

$$\begin{matrix}{\sum }_{i = 1}^{N} {( \frac{Δ V}{{V}_{i}} )}^{2} & ( 3 ) \\ {\sum }_{i = 2}^{N} {( \frac{Δ V}{{V}_{i}} - \frac{Δ V}{{V}_{i - 1}} )}^{2} & ( 4 )\end{matrix}$$

Importantly, multiple regularisation terms can be combined in the warping cost function, such as for example, using both equation 3 and equation 4 to simultaneously constrain both the total energy of the solution and the size of deviations between adjacent model parameters, yielding smooth solutions with small energy.

L₂ Tikhonov regularisation penalises model parameters in the same manner that ordinary least squares penalises data noise—according to the Normal distribution. Large parameter or data values are assumed to be improbable and are penalised in inverse proportion to their probability of occurrence. This does not imply that the final solution parameters will be Normally distributed, but only that each is penalised according to its improbability based on the Normal distribution. As discussed before, Tikhonov regularisation can be applied also to the spatial or temporal gradient of the model as well, penalising deviations in adjacent model parameters. Since large deviations would be quite improbable according to the Normal distribution, this yields smooth model solutions.

At the same time, although seismic processing is generally quite effective to eliminate data noise, special problems arise with 4D seismic data because data acquisition is not perfectly repeatable between base and monitor surveys, and this can constitute a significant source of noise artefacts in the data. Tikhonov regularisation tends to over-fit models to this noise, yielding model solutions with significant 4D deviations in areas where they are very improbable, notably in the over- and underburden and between reservoir intervals. Moreover, inasmuch as Tikhonov regularisation is able to attenuate model noise in regions where 4D changes are expected to be minimal, so too does it attenuate genuine 4D changes in regions where they are expected to be maximal (e.g., reservoir intervals), an undesirable artefact of this regularisation scheme.

The quest for more reliable and quantitative results is a genuine stake for every 4D project because the correctness of the results has a big impact on their subsequent application in later workflows. For example, reliable 4D results can be used to perform 4D-assisted history matching or as an input to 4D petrophysical inversion, both of which can lead to improved geo-models with greater confidence of accuracy. Even a slight improvement in a reservoir geo-model can require significant changes in field management decisions, such as the choice of infill wells or injectors. Where it has already been applied, 4D has had a major impact on production, increasing yields by up to a millions of barrels of oil equivalent. Thus, a poor warping inversion based on an unsuitable choice of model regularisation not only limits the quantitative use of 4D data, it can be quite detrimental to qualitative results as well.

Another serious drawback in the previous art is that genuine 4D signals of interest in the data sometimes have a magnitude only slightly greater than the noise level. Interpreters often have to establish a threshold above which they trust 4D signal; below this value they must reject everything. This is a very important choice which is made early in the assessment of 4D results. Consequently, it would be desirable to improve the correctness of 4D results in order to make interpretation a threshold-free process

It would be desirable therefore to provide a process for characterising the evolution of a reservoir which is more data driven and thus does not make use of as much model information as a full elastic inversion. A clear benefit of data-driven warping is that there is a very quick turnaround, because warping results can be achieved in few weeks while elastic inversion results are usually obtained in few months. Turnaround is an important element to determine the value of information because any delays greatly diminish the impact of any information in managing a reservoir.

It is an object of the present invention to provide a process for characterising the time evolution of a petroleum reservoir, that mitigates at least some of the problems in the prior art.

The invention provides a process for characterising the evolution of a reservoir by co-analyzing the changes in the propagation times and seismic amplitudes of seismic reflections, comprising the steps of:
providing a base survey of the reservoir with a set of seismic traces at a first time;
providing a monitor survey of the reservoir, taken at a second time, with a set of seismic traces associated to the same positions as in the base survey;
characterising the evolution of the reservoir by inversion to obtain an estimate of the changes having occurred during the time interval between base and monitor surveys,
wherein said inversion is regularized by the imposition of a sparsity constraint, said sparsity constraint favouring inversion solutions for which most of the solution values are substantially equal to zero, while large values of said inversion solutions are substantially preserved.

In another embodiment, the invention provides a computer program residing on a computer-readable medium, comprising computer program code means adapted to run on a computer all the steps of such a process.

Other option features and aspects of the invention are as described in the appended dependent claims.

### BRIEF DESCRIPTION OF THE DRAWINGS

A process embodying the invention will now be described, by way of example only, and with reference to the accompanying drawings, of which:

FIGS. 1(a) and (b) are schematic illustrations of a (a) base survey and (b) monitor survey being performed;

FIG. 2 shows typical Cauchy and Gaussian distribution curves on the same axes;

FIG. 3 shows two solutions of ΔV/V (from the real base-monitor seismic traces) obtained using a previous Normal distribution based regularisation method and a Cauchy-based method respectively; and

FIG. 4 shows post-inversion residuals and integrated squared residuals for the two model solutions shown in FIG. 3.

### DETAILED DESCRIPTION OF THE EMBODIMENTS

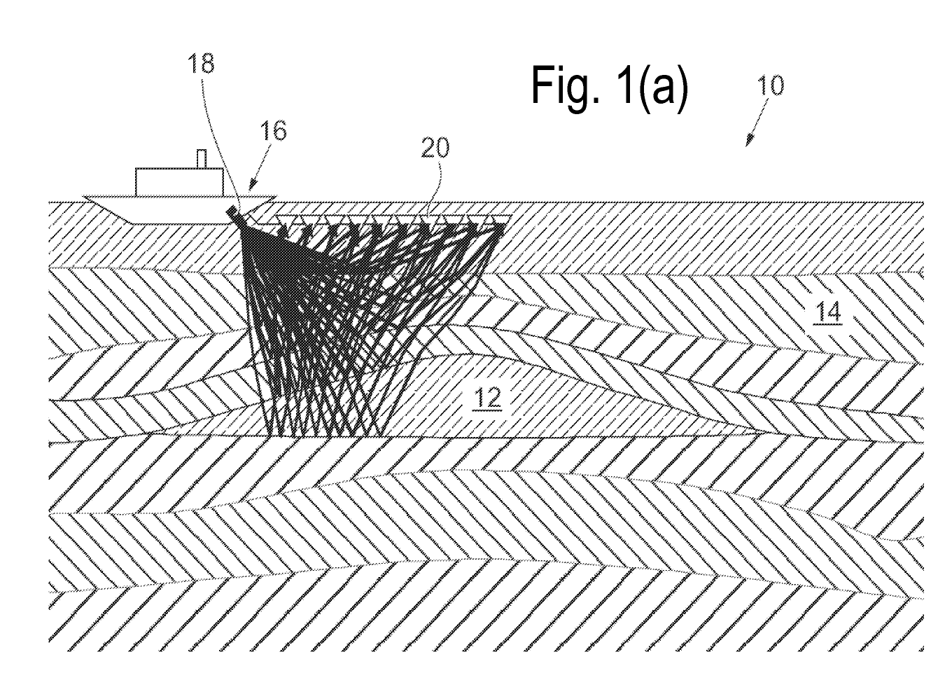

Referring initially to FIGS. 1(a) and (b) there is illustrated a reservoir, generally indicated by reference numeral 10, containing hydrocarbons 12 in the sub-surface 14. A survey vessel 16 upon which is located a sonar transmitter 18, being an acoustic source, and an array of receivers 20, performs a survey by travelling over the reservoir 10. The first or initial survey, FIG. 1(a), may be referred to as a base survey and is typically performed in the exploration phase before production begins.

The base survey of the reservoir 10 provides a set of seismic traces at a first time T. For a given trace, the base survey provides an amplitude b(t), that is an amplitude which is a function of time t; with digital recording and processing the trace is sampled at a set of values tᵢ, with i an index; typical trace lengths correspond to around 1000 samples. The trace is then handled as a set of values b(tᵢ) or bᵢ.

One or more wells 22 may be drilled in order to extract the hydrocarbons 12. As the reservoir 10 is produced oil will be substituted by gas or water and the fluid pressure will change. Additionally, enhanced oil recovery techniques may be applied wherein a fluid is injected into the reservoir at one or more locations giving changes in fluid pressure. Changes within the reservoir may also change the stress and strain state of the surrounding rocks. Thus when a further survey is carried out, FIG. 1(b), these changes will be seen due to a consequential change in the velocity field. These changes to velocity will produce time shifts in the seismic expression of underlying reflectors and associated changes in reflectivity, causing a change in the local wavefield.

Thus reservoir monitoring performs a monitor survey of the reservoir 10, taken at a second time T+ΔT, with a set of seismic traces. In the simplest assumption, T is a positive quantity, and the monitor survey is taken at a time later than the base survey; however, the order in which the surveys are taken is irrelevant to the operation of the process of the invention and, in principle, the time lapse T could as well be negative—which amounts to comparing the earlier survey to the later one. As for the base survey, a sampled trace in the monitor survey is represented as a set of values m(tᵢ) or mᵢ.

Ideally, the traces in the monitor survey are associated to the same positions as in the base survey. This is carried out by using, inasmuch as possible, the same equipment, acquisition geometry and processes for running the base survey and monitor survey. Practically speaking, a difference of 5-10 m between the positions of sources and receivers still leads to acceptable results. Techniques such as interpolation may be used where traces in the monitor survey and in the base survey do not fulfil this condition.

As in the prior art we apply warping to reconcile the differences between base and monitor seismic traces due to 4D changes. EP 1 865 340 cast the warping as a non-linear inverse problem to obtain an interval attribute such as relative velocity change (or time strain). The inversion is posed as a least squares optimisation with respect to the velocity change parameters as illustrated in Equation (1); the best-fitting model is that which mediates the best match between the shifted (warped) monitor trace and the amplitude-adjusted base trace. The main assumptions in this equation are that (i) wave propagation is nearly vertical, (ii) velocity varies smoothly laterally and (iii) there is no compaction above or in the reservoir. The first assumption can be dispensed with if the cost function disclosed in GB 1005646.3 is used.

The inventors have recognised that, for non-compacting reservoirs, 4D effects are expected to occur chiefly in permeable, porous faces within the reservoir interval. This is essentially a sparsity assumption on the elastic model. A general definition for sparse, sparsity or sparseness is something small in numbers or amount, often scattered over a large area. These terms are therefore referred to something lacking denseness.

In numerical analysis, a sparse matrix is a matrix populated primarily with zeros. Another informal definition is a matrix with enough zeros that it pays to take advantage of them. In general it is not always possible to quantify a percentage of non-zero elements needed to make a matrix sparse, in fact the position of the non-zero elements can matter as well. Consequently, what makes the 4D model sparse is not just the amount of substantially zero samples but also the fact that it has non-zero values just for small portions of adjacent samples of the seismic trace. In non-compacting reservoirs 80-90% of relative changes in material properties are substantially zero. This makes the same proportion of the model samples equal to zero. These sparse samples can have significant relative velocity changes (or time strain) up to 15-20%.

A common type of reservoir often encountered in the petroleum industry is the non-compacting reservoir, comprising multiple, thin-layer pay zones sandwiched between interstitial, non-productive layers and surrounded above and below by non-pay over- and underburden. In this case, only the reservoir units, which constitute a minor fraction of the total model (including interstices and over-/under-burden), are expected to cause significant changes between base and monitor seismic surveys; the remainder (and majority) of the model is expected to induce effectively no change. Since the 4D model values for such a reservoir are expected to be mostly zero with a few large deviations (i.e sparsity) corresponding to thin pay zones, the inventors have recognised that this reservoir type cannot be properly modelled by a Normal distribution and hence is inconsistent with L₂ Tikhonov regularisation. Applied to the model, L₂ Tikhonov regularisation precludes large model values, forcing them to be smaller than they likely are; and when applied to the model gradient, it precludes large deviations between adjacent model values, forcing un-physical, over-smooth solutions. With thin reservoir layers, L₂ Tikhonov regularisation over-penalises areas where there are abrupt, strong time lapse effects, making the solution purely qualitative and not exploitable for quantitative purposes.

Let model vector m denote the discrete profile of ΔV/V corresponding with data d_{b} and dₘ, the observed base and monitor seismic traces, respectively. Denote the nonlinear relationship between ΔV/V and the base and monitor traces as

d_{b}=g(m,dₘ). (5)

The function g is a warping operator that nonlinearly maps (warps) dₘ and m to d_{b}, such as the cost function of equation (1). The object is to invert d_{b} for m, given dₘ and subject to the constraint that m is sparse.

Leptokurtotic probability density functions are ‘peaky’ distributions with heavy tails that, when adapted as regularisation functionals, favour sparse solutions because they constrain the majority of solution values to be near zero while allowing some fraction to take significantly non-zero values. The Gaussian and Laplace distributions used respectively for L₂ and L₁ Tikhonov regularisation are not especially leptokurtotic and are therefore not well suited to mediate sparse solutions.

An alternative is to use Cauchy regularisation via the so-called Cauchy-norm, which was originally introduced to impose sparsity to frequency spectra. The Cauchy distribution can be made as leptokurtotic as desired through a governing scale parameter.

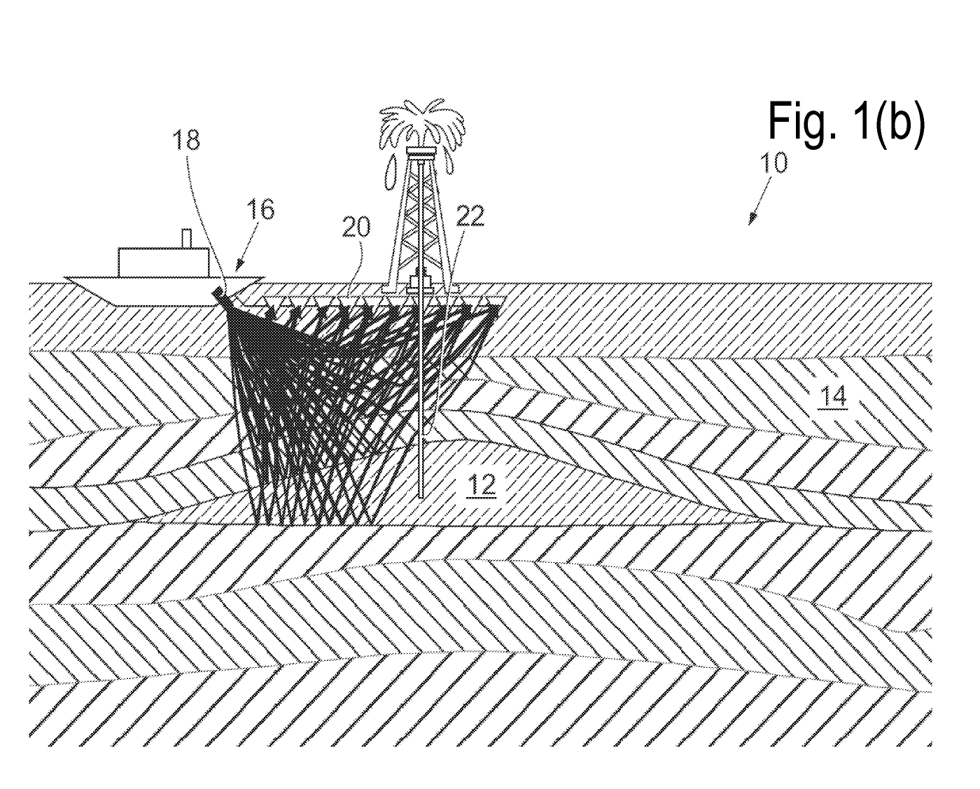

FIG. 2 shows Cauchy (labelled A) and Gaussian (labelled B) distributions. Both can be used to impose an expected frequency of model values in warping inversions, the former mediating Cauchy regularisation and the latter classic Tikhonov regularisation. The Cauchy distribution is spiky with slowly decaying tails and thus forces most model values to be close to zero while allowing a few to deviate significantly from zero. In contrast, the Gaussian distribution is broader with more rapidly decaying tails, thus allowing model values to be more spread out in magnitude but without large deviations.

In view of the above it is proposed to introduce a model regularisation method to 4D warping that imposes sparsity via the Cauchy norm of the model. Note that sparsity can be applied to the model

$$m [ i ] \to \frac{Δ V}{{V}_{i}}$$

in equation (6) below) and/or its spatial gradient (

$$m [ i ] \to \frac{Δ V}{{V}_{i}} - \frac{Δ V}{{V}_{i - 1}}$$

in equation (6) below).

In a main embodiment two regularisation terms may be used, one applying sparsity to the model and the other applying sparsity to the spatial gradient. In such a case the two terms are added to the warping cost function, each having its own scale parameter, set as appropriate. In the first case the model constraint will assume that most values are zero but places minimal constraint on high values. Similarly, the spatial gradient constraint will assume zero change between adjacent values most of the time (as most values are zero), but will not necessarily constrain large deviations between adjacent values when encountered. This makes sparsity particularly suited for regularising non-compacting reservoirs.

The Cauchy norm is defined as

κ(m)≡Σᵢ₋₁^{M} ln(1+m[i]²/β²), (6)

where m[i] is the i^{th} of M (assumed) independent and identically distributed elements of m and β is the aforementioned scale parameter. To implement Cauchy sparsity in a Gauss-Newton algorithm, it is proposed to begin with the objective (or cost) function (equivalent to equation (2)):

Φ≡∥W[d_{b}−g(m₁,dₘ)]∥₂²+λ∥k(m₁)∥₂². (7)

The first term is the least squares misfit between the observed base trace and warped monitor trace for model m₁; w is a data weighting matrix, typically the inverse (matrix) square root of the data uncertainty covariance matrix; A, is a non-negative Lagrange parameter that controls the tradeoff between the misfit and regularisation constraints. The second term in equation (7) is the Cauchy norm expressed in pseudo-quadratic form, where (using element-wise operations):

$$k ( {m}_{1} ) = {[ ln ( 1 + {m}_{1}^{2} / β ) ]}^{\frac{1}{2}} . \qquad ( 8 )$$

Linearizing g(m₁) and k(m₁) gives:

g(m₁)=g(m₀+Δm)≈g(m₀)+GΔm

k(m₁)=k(m₀+Δm)≈k(m₀)+KΔ′ (9)

where G and K are correspondingly the Jacobians of g and k with respect to m. Substituting equation (9) into equation (7) and setting its gradient with respect to Δm to zero produces the regularized normal equation:

(G^{T}G+λK^{T}K)Δm=G^{T}[d−g(m₀)]−λK^{T}k(m₀), (10)

where K(m₀)=diag[m₀/(m₀²+β²)/k(m₀)] (element-wise operations). Solving for Δm yields the Gauss-Newton update,

Δm=(G^{T}G+λK^{T}K)⁻¹{G^{T}[d−g(m₀)]−λK^{T}k(m₀)}, (11)

which is added to the current solution at each iteration of the Gauss-Newton algorithm until convergence. As stated earlier, expressions (7) to (11) can be modified to include not only the sparsity of the model but the sparsity of its gradient ∇m as well, giving the alternate model update

Δm′=(G^{T}G+λₘKₘ^{T}Kₘ+λ_{∇}K_{∇}^{T}K_{∇})⁻¹{G^{T}[d−g(m₀)]−λₘKₘ^{T}kₘ−λ_{∇}K_{∇}^{T}k_{∇}}, (b 12)

where Kₘ=K(m₀), K_{∇}≡K(∇m₀), kₘ≡k(m₀), k_{∇}≡k(∇m₀), and λₘ and λ_{∇} are the corresponding Lagrange parameters. The m-subscript corresponds to a Cauchy sparsity constraint on the model while the ∇-subscript corresponds to a Cauchy sparsity constraint on the gradient of the model. The two constraints combine to favor blocky solutions (gradient constraint) with a majority of zero values (model constraint).

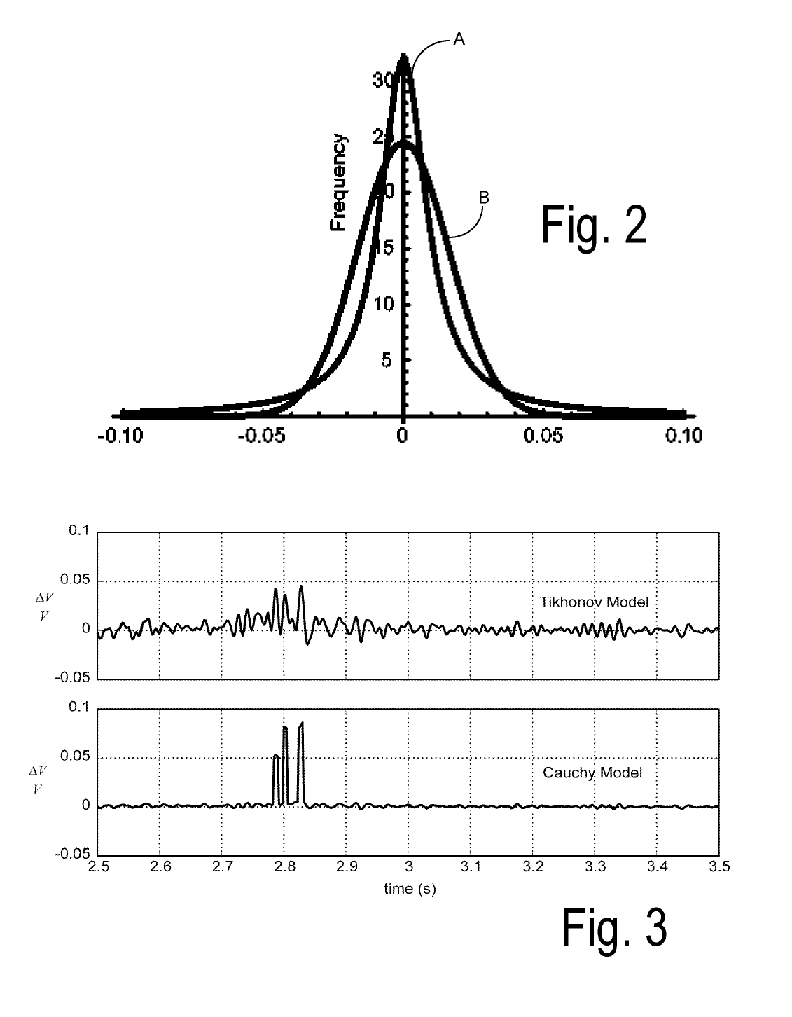

FIG. 3 compares ΔV/V solutions using a previous Gaussian based regularisation (L₂ Tikhonov) and the Cauchy based regularisation. In both cases, regularisation has been applied to the model and its gradient. The data comes from an offshore field currently under production. The pay zone of this reservoir comprises relatively low-permeability muddy turbidite deposits interlaced with unconsolidated, high permeability oil-bearing sands. A 4D image of these sand beds is thus expected to be sparse, that is, thin interstices of large deviation against a background of (near-)zero deviation.

The ‘Tikhonov model’ is visibly noisier than the ‘Cauchy model’, and the Cauchy model shows extremely well-defined 4D anomalies interpretable as sandy intervals, which are over-smoothed or unresolved in the Tikhonov model. Additionally, the magnitude of ΔV/V in the inferred sand beds in the Cauchy model is much larger.

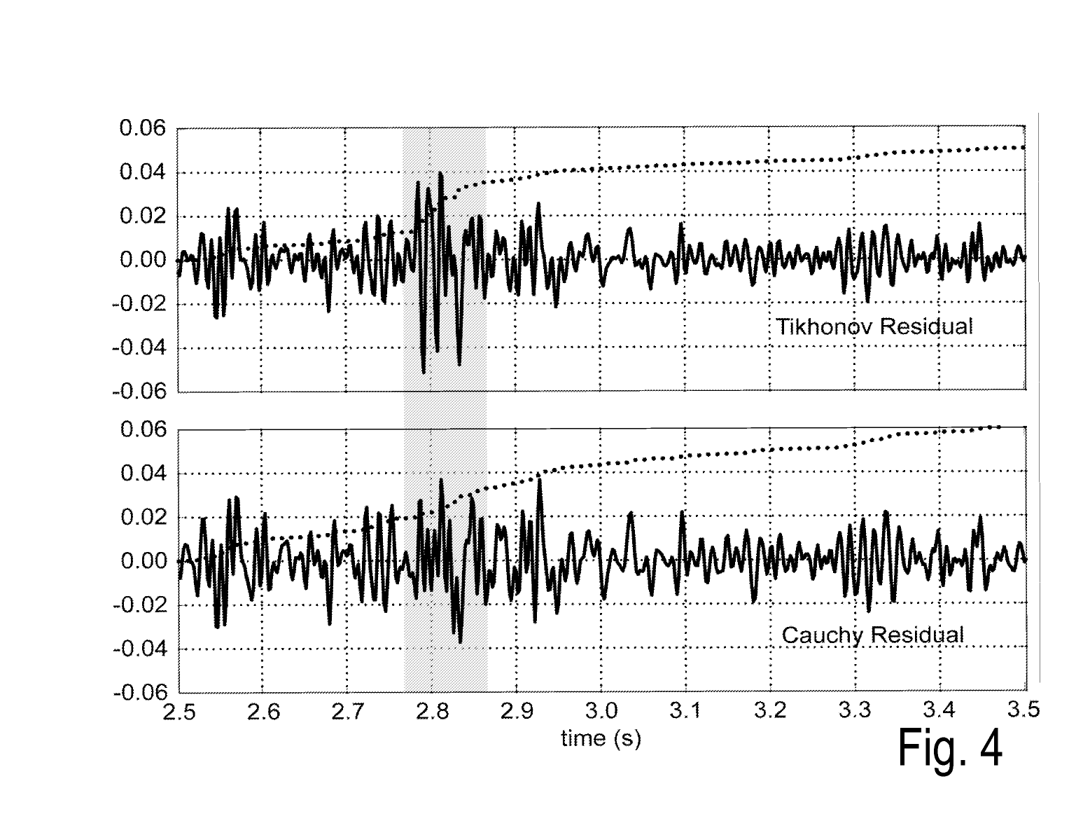

FIG. 4 shows post-inversion residuals (solid lines) and integrated squared residuals (dotted lines) for corresponding to the model solutions in FIG. 3. The value of the integrated residuals on the right hand side equals the sum of squared residuals for that inversion. In theory, the background data noise for this field is expected to be coherent though stationary; it should smoothly vary without intervals of significant modulation. These residuals show that Cauchy sparsity appears to better honour this assumption. The ‘Cauchy residual’ exhibits less transient (non-stationary) structure than the ‘Tikhonov residual’, especially at around 2.8 s (shaded area), where there is clearly a 4D anomaly in the base and monitor traces. This is also apparent from the integrated squared residuals in FIG. 4, where there is a sudden jump in the integral of the squared ‘Tikhonov residual’. Assuming residuals are stationary, their integrated squares should increase smoothly, which is seen with the ‘Cauchy residual’ but not with the ‘Tikhonov residual’. Note also that the integrated squared ‘Cauchy residual’ is actually larger than that for the ‘Tikhonov residual’, which we discuss below.

For the real data example discussed above, Cauchy sparsity regularisation is evidently superior in all respects to Tikhonov regularisation. The model resulting from Cauchy regularisation is sharper, far less noisy, and the magnitude of ΔV/V in inferred sand layers is greater than that obtained using Tikhonov regularisation. In all respects, the Cauchy results agree well with our prior knowledge that the reservoir comprises interstitial thin sand beds. Thus, the selection of the Cauchy distribution as a sparse probabilistic representative of this 4D reservoir model is validated. While the Tikhonov image does capture features consistent with our reservoir assumptions, it lacks clear delineation (resolution) and is significantly contaminated by numerical artifacts (chiefly noise and smoothed anomalies).

In this example, the Cauchy norm leads to residuals that are more representative of the expected background noise. Residuals are similar in character from beginning to end with no transient structure, in compliance with our assumption that data noise should be approximately stationary. In contrast, the ‘Tikhonov residuals’ show that the Tikhonov inversion over-fits noise in the data (the sum of squared residuals is smaller than that for the ‘Cauchy residual’, and the resulting image is noisier, meaning coherent data noise has mapped into the model) and under-fits actual 4D signal (there is still a transient apparent in the ‘Tikhonov residual’ around 2.8 s). The ‘cleanness’ of the Cauchy image and the stationarity of the coherent residual leads us to conclude that Cauchy sparsity is particularly robust to suppress coherent data noise and attendant imaging artifacts for thin reservoir models.

It is possible in principle to jointly optimize the scaling parameters λₘ and λ_{∇} using for example a 2D L-curve method or possibly the Levenberg-Marquardt algorithm to dynamically control both variables.

The process of the invention may be embodied in a computer program. The program is adapted to receive data for the base and monitor surveys, as well as data for the velocity fields; such data are in the format provided by state of the art computer packages known to those skilled in the art. The program runs the various steps of the process described herein.

It will be appreciated by those skilled in the art that modifications may be made to the invention herein described without departing from the scope thereof. For example, while we have followed the cost function as taught in the prior art, any seismic match portion of the cost function can be selected to suit the data. Additionally while we have considered the evolution of a reservoir over monitored time periods and the changes when fluids are injected into the reservoir to aid production, it will be appreciated that the process can be used to monitor the injection of CO₂ into redundant wells.

Cauchy sparsity provides such robust results that it can be applied to warping inversions to invert for more than one elastic parameter. In particular it can be used to invert for relative change in P-wave velocity, S-wave velocity and/or relative change in density. In this case the results of the warping inversion using multi-monitor warping techniques and/or pre-stack warping techniques (as described in GB0909599.3 and GB1005646.3 respectively, both documents being hereby incorporated herein by reference), which are improved by increasing the amount of data used by the warping inversion, can be further improved by the application of sparsity constraints. In cases in which the signal to noise ratio and the repeatability between base and monitor are favourable, the sparsity regularisation enables obtaining accurate results and multi-elastic parameters without the addition of pre-stack or multi-vintage information.

1. A process for characterising the evolution of a reservoir by co-analyzing the changes in the propagation times and seismic amplitudes of seismic reflections, comprising the steps of:
providing a base survey of the reservoir with a set of seismic traces at a first time;
providing a monitor survey of the reservoir, taken at a second time, with a set of seismic traces associated to the same positions as in the base survey;
characterising the evolution of the reservoir by inversion to obtain an estimate of the changes having occurred during the time interval between base and monitor surveys; and
wherein said inversion is regularized by the imposition of a sparsity constraint, said sparsity constraint favouring inversion solutions for which most of the solution values are substantially equal to zero, while large values of said inversion solutions are substantially preserved.

2. The process as claimed in claim 1, wherein said sparsity constraint is applied to the model parameters, said sparsity constraint preferring solutions for which the majority of values are substantially zero but permitting a small fraction of large values.

3. The process as claimed in claim 1, wherein said sparsity constraint is applied to the spatial derivative of the model parameters, said sparsity constraint favouring solutions where the majority of values of said spatial derivative are zero, but permitting solutions with a small number of sharp contrasts in 4D changes over the time lapsed between base and monitor surveys.

4. The process as claimed in claim 1 comprising:
making joint use of a first sparsity constraint and a second sparsity constraint;
wherein the first sparsity constraint is applied to the model parameters, said first sparsity constraint preferring solutions for which the majority of values are substantially zero but permitting a small fraction of large values; and
wherein the second sparsity constraint is applied to the spatial derivative of the model parameters, said second sparsity constraint favouring solutions where the majority of values of said spatial derivative are zero, but permitting solutions with a small number of sharp contrasts in 4D changes over the time lapsed between base and monitor surveys.

5. The process as claimed in claim 1, wherein said model parameters comprise the relative velocity changes between said base survey and said monitor survey.

6. The process as claimed in claim 1, wherein said sparsity constraint does not penalise solutions having a small number of solution values in the region of +/−20%.

7. The process as claimed in claim 1, wherein said sparsity constraint does not penalise solutions having a small number of solution values in the region of +/−15%.

8. The process as claimed claim 1, wherein said sparsity constraint does not penalise solutions having a small number of solution values in the region of +/−10%.

9. The process as claimed in claim 1, wherein said sparsity constraints favours inversion solutions for which 80% or more of the solution values are substantially equal to zero.

10. The process as claimed in claim 1, wherein said sparsity constraints favour inversion solutions for which 90% or more of the solution values are substantially equal to zero.

11. The process as claimed in claim 1, wherein said sparsity constraint is used to perform an inversion for two or more parameters.

12. The process as claimed in claim 11, wherein said two or more parameters include: relative p-wave velocity or slowness change, relative density change and relative s-wave velocity or slowness change.

13. The process as claimed in claim 1, wherein said inversion is carried out for time strain.

14. The process as claimed in claim 1, wherein one or more of said at least one regularisation term is derived from the Cauchy distribution.

15. The process as claimed in claim 14, wherein one or more of said at least one regularisation term takes the form of:
κ(m)≡Σᵢ₋₁^{M} ln(1+m[i]²/β²),
where m[i] is the i^{th} of M assumed independent and identically distributed elements of m and β is a scale parameter.

16. The process as claimed in claim 1, wherein the sparsity constraint is applied to a subset or oversample of the model parameters.

17. The process as claimed in claim 1 further comprising the step of using the resultant data to aid hydrocarbon recovery from said reservoir.

18. A computer program residing on a computer-readable medium, comprising computer program code means adapted to run on a computer all the steps of the process of claim 1.

19. An apparatus specifically adapted to carry out all the steps of any of the processes as claimed in claim 1.
